(19) United States
(12) Patent Application Publication
(10) Pub. No.: US 2009/0243553 A1
(43) Pub. Date: Oct. 1, 2009

(54) METHOD AND SYSTEM FOR POWER AND CHARGING CONTROL IN A BLUETOOTH HEADSET

(76) Inventors: John Walley, Ladera Ranch, CA (US); Domitille Esnard, Biot (FR)

Correspondence Address: MCANDREWS HELD & MALLOY, LTD, 500 WEST MADISON STREET, SUITE 3400, CHICAGO, IL, 60661, US

(21) Appl. No.: 12/054,588

(22) Filed: Mar. 25, 2008

(51) Int. Cl. H02J 7/00

(52) U.S. Cl. 320/162

(57) ABSTRACT

Methods and systems for power and charging control in a Bluetooth headset are disclosed and may include measuring a load current during charging of batteries in a mobile device. A completion time of the charging may be predicted. The charging may be terminated based on a sum of the load current and a known charge complete threshold current of the batteries, which may include lithium batteries. A current or voltage source may be controlled for the charging. A current from the current source may be compared to the sum via a current comparator. A rate of charging may be controlled for charging to a desired end voltage based on the predicted completion time. A user preference based on the predicted completion time may be stored, where the user preference may be utilized to control one or more subsequent charges.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to audio headphones. More specifically, certain embodiments of the invention relate to a method and system for power and charging control in a Bluetooth headset.

### BACKGROUND OF THE INVENTION

Headphones were originally utilized for personal enjoyment of music without distracting other people in the vicinity of the music source. Headphones may comprise circumaural, earphones, and canal phones. Circumaural headphones cover the ears and are rather large, more attuned for home audio applications as compared to use with portable audio devices. Earphones are typically used in portable audio device applications, with cassette tape, compact disc and MP3 players, for example. The application of earphones later extended into cellular phone applications, typically as a single earpiece, as the danger of operating motor vehicles while utilizing a cellular phone was established.

With the development of wireless technology, wireless headphones have become more and more prevalent. Bluetooth headsets and/or earpieces have expanded significantly in usage as more cellular phone users have discovered the ease of use with hands-free operation, not only in automotive applications, but in any application where hands-free operation is preferred.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for power and charging control in a Bluetooth headset, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless headset, in accordance with an embodiment of the invention.

FIG. 2 is a block diagram of an exemplary battery charging profile, in accordance with an embodiment of the invention.

FIG. 3 is a block diagram of exemplary circuitry for controlling battery charging with a load coupled to the battery, in accordance with an embodiment of the invention.

FIG. 4 is a block diagram illustrating an exemplary battery charge and recharge process, in accordance with an embodiment of the invention.

FIG. 5 is a flow diagram illustrating an exemplary charging operation of a wireless headset, in accordance with an embodiment of the invention.

### DETAILED DESCRIPTION OF THE INVENTION

Certain aspects of the invention may be found in a method and system for power and charging control in a Bluetooth headset. Exemplary aspects of the invention may comprise measuring a load current during charging of one or more batteries in a mobile device, such as a Bluetooth headset. The charging of the batteries may be terminated based on a sum of the measured load current and a known charge complete threshold current of the batteries, which may comprise lithium batteries. A current or voltage source may be controlled for the charging of the batteries. A current from the current source may be compared to the sum of the measured load current and the known charge complete threshold current via a current comparator. A rate of charging may be controlled for charging to a desired end voltage based on the predicted completion time. A user preference based on the predicted completion time may be stored, where the user preference may be utilized to control one or more subsequent charges.

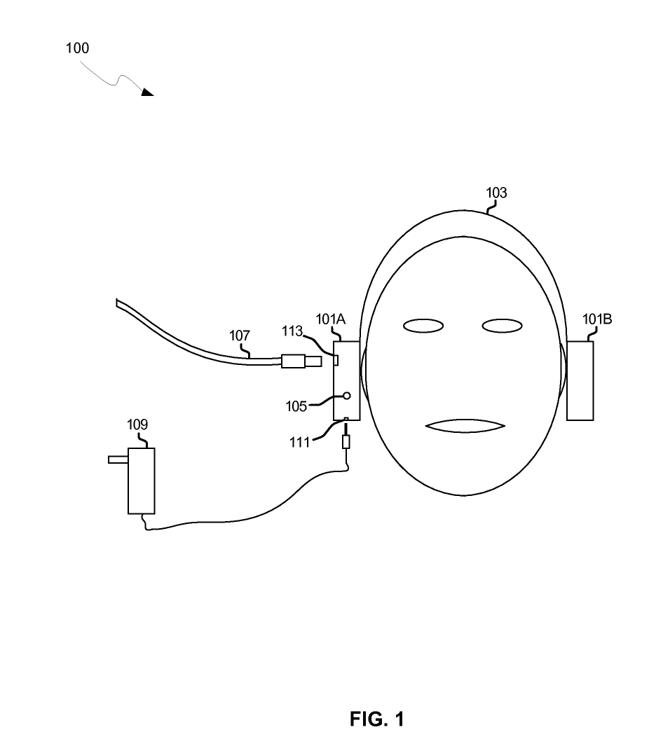

FIG. 1 is a block diagram of en exemplary wireless headset, in accordance with an embodiment of the invention. Referring to FIG. 1, there is shown wireless headset 100 comprising ear pieces 101A and 101B and a support piece 103. The support piece 103 may provide support and/or electrical connection for the two ear pieces 101A and 101B. The ear piece 101A may comprise a light emitting diode (LED) 105, a charging port 111 and a USB port 113. The ear pieces 101A and 101B may also comprise one or more circuits and one or more batteries for controlling and powering of the wireless headset 100, respectively, which may be located internal to the wireless headset 100. The wireless headset 100 may comprise a stereo or mono Bluetooth headset, for example. There is also shown a charger 109 and a USB cable 107. In another embodiment of the invention, the wireless headset 100 may be charged via the USB port 113, eliminating the need for the charging port 111.

The charger 109 may comprise suitable circuitry, logic and/or code that may be enabled to charge the batteries in the wireless headset 100. The USB cable 107 may comprise a standard USB cable that may be utilized to couple the wireless headset 100 to an external device, such as a computer, for example. The USB cable 107 may be utilized to configure the wireless headset 100, for example, and may also be utilized to charge the batteries in the wireless headset 100.

The LED 105 may comprise a visible LED that may be utilized to indicate a status of the wireless headset 100 during a charging process, for example, utilizing the charger 109 via the charging port 111 or utilizing the USB cable 107 via the USB port 113. The number of LEDs utilized on the wireless headset 100 may not be limited to the one LED 105 shown in FIG. 1. Accordingly, any number of LEDs may be utilized depending on the number of functions and/or states to be indicated.

In operation, the wireless headset 100 may be powered by a battery internal to the wireless headset 100. The wireless headset 100 may be enabled to playback audio signals received wirelessly from sources such as an FM or Bluetooth transmitter, for example. In instances when the battery voltage may drop below a threshold value required to power the wireless headset 100, an external power source, such as the charger 109 and/or the USB cable 107 may be coupled to the wireless headset 100. In an embodiment of the invention, the wireless headset 100 may be enabled to accurately charge the one or more batteries in the earpiece 101A and/or 101B by determining the current load on the one or more batteries during charging. In this manner, the measured load current may be taken into account when determining when to terminate the charging of the one or more batteries.

In another embodiment of the invention, the load current may be estimated from the expected power consumption in the current high level state, in instances where the load current may not be directly measured. Current states may be measured and stored in memory at the time of manufacture for known states of the headset 100, such as when it is simply charging, when it is charging and performing USB operations, and charging and transmitting, for example. Accordingly, in instances where the headset 100 may not have the capability of directly measuring load current, this value may be estimated by the original measurement of the known state at manufacture.

In an exemplary embodiment of the invention, the LED 105 may indicate whether the charging process enabled by the charger 109 and/or the USB cable 107 may be functioning properly. The one or more batteries may be switched off from the circuitry in the wireless headset 100, and the voltage from the charging source may be used to directly power the wireless headset 100. The circuitry that may be enabled during the charging process may comprise power handling circuitry, such that the wireless headset 100 may be enabled to determine the approximate charging time and/or charging current that may be needed to completely charge the one or more batteries. In this manner, charging algorithms may be adjusted by the power handling circuitry to optimize the battery lifetime and the charging time.

In an embodiment of the invention, the charging of the one or more batteries in the headset 100 may be controlled to optimize the battery lifetime and charge state. A battery may be fully charged when the charging current falls to a charging threshold value. Accordingly, in applications where a load may be coupled to the one or more batteries during charging, the wireless headset 100 may be enabled to sense the load current and compensate for this sensed load current from the total current so that the charging may finish at the correct threshold current level for the particular battery.

In another embodiment of the invention, the charge/recharge cycle of the one or more batteries in the wireless headset 100 may be controlled such that the charge may complete as the charge state just reaches the 100% point. Conventional battery charging implementations may not control the timing of the charge, so that when the system may be disconnected from the charger, the battery may be in a recharge state, or less than 100% charged.

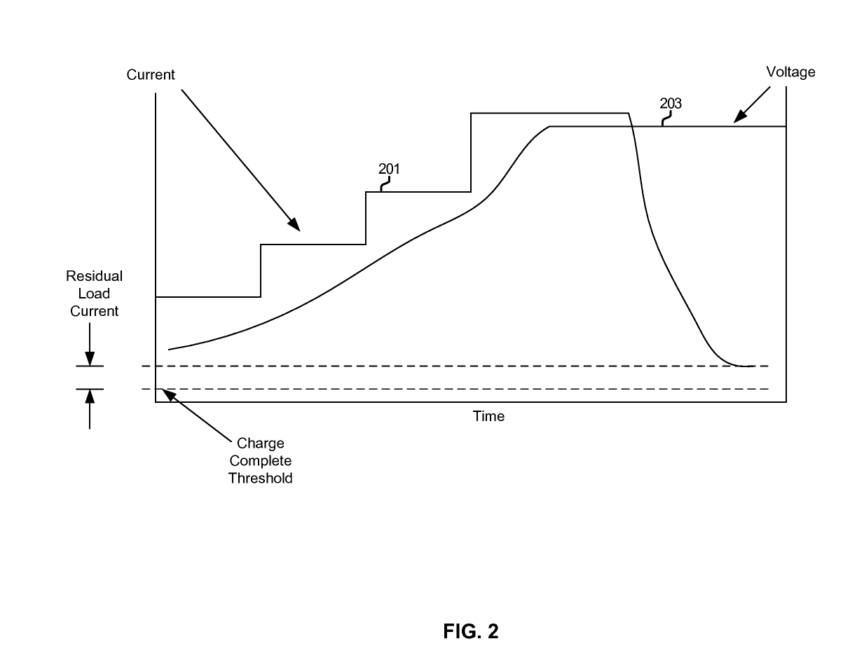

FIG. 2 is a block diagram of an exemplary battery charging profile, in accordance with an embodiment of the invention. Referring to FIG. 2, there is shown a battery charging profile 200 comprising a current profile 201 and a voltage profile 203. The current profile 201 may represent the current supplied to the one or more batteries in the wireless headset 100, described with respect to FIG. 1. The voltage profile 203 may represent the voltage across the one or more batteries. As a battery reaches the fully charged state during the charging process, the voltage may reach a maximum value and the current may drop to a value that is typical of the particular type of battery, lithium ion, for example, when fully charged.

For optimum battery lifetime, it may be advantageous to have no load on the batteries during charging. However, in instances where it may not be possible to completely remove any load from the battery during charging, taking into account the load current may enable the accurate charging of the battery.

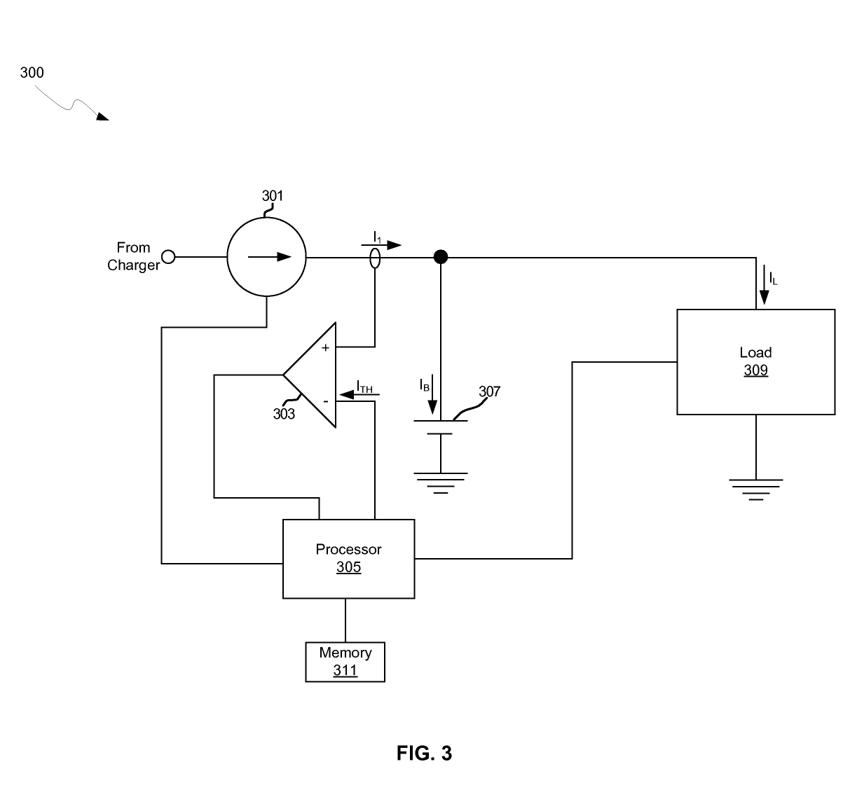

In operation, during a charging process of a battery, such as the one or more batteries in the wireless headset 100, described with respect to FIG. 1, the supplied current may be incrementally increased as the voltage across the battery increases. The current required for charging may reach a peak and then fall to a threshold level to indicate that the charging may be complete. A constant voltage may be applied to the battery once the maximum voltage may be obtained, while the current reduces to the threshold level. In instances when a load may be coupled to the one or more batteries during charging, the supplied current may not be equal solely to the charging current. Accordingly, for an accurate determination of the charging current, the load current may be taken into account, such that it may be subtracted from the total supplied current. In this manner, when the correct charge complete threshold current may be reached, the charging may be complete. The number of steps in the current profile 201 is not limited to the number shown in FIG. 2. Accordingly, and number of steps may be utilized, according to the optimum charging profile for the particular battery being used. In An exemplary circuit enabling this compensation is described with respect to FIG. 3.

FIG. 3 is a block diagram of exemplary circuitry for controlling battery charging with a load coupled to the battery, in accordance with an embodiment of the invention. Referring the FIG. 3, there is shown charging control implementation 300 comprising a current source 301, a current comparator 303, a processor 305, a battery 307, a load 309 and a memory 311. There is also shown currents I₁, I_{B}, I_{TH} and I_{L}.

The current source 301 may comprise suitable circuitry, logic and/or code that may enable supplying a current, I₁, which may be utilized to charge the battery 307. The current source 301 may receive as an input, a voltage that may be supplied by a charger, such as the charger 109, described with respect to FIG. 1, and may be enabled to supply a controlled amount of current depending on the requirements of the battery being charged and the coupled load, such as the load 309. The current source 301 may be controlled by the processor 305, which may adjust the current level supplied by the current source 301.

The current comparator 303 may comprise suitable circuitry, logic and/or code that may enable comparing current levels via signals communicated to its inputs and generating an output signal that may transition from high to low, or from low to high, when the current sensed by the ‘+’ input exceeds the current sensed by the ‘−’ input. The current comparator 303 may sense current by measuring a voltage across a sense resistor or via a Hall effect voltage, for example. The output signal generated by the current comparator may be utilized to indicate the completion of a charging process, such as the charging process described with respect to FIG. 2, and may be communicated to the processor 305.

The battery 307 may comprise one or more batteries in a wireless device, such as the wireless headset 100, described with respect to FIG. 1. The battery 307 may comprise one or more lithium ion batteries, for example, and may sink a known amount of current when fully charged, such that the completion of the charging process of the battery 307 may be determined by monitoring the current I_{B}. The charge complete threshold current and/or the optimum fully-charged voltage for various batteries that may be used in the wireless headset 100 may be stored in a lookup table, for example, which may be stored in the memory 311. However, measuring only the battery current I_{B}, may not easily be determined when a load, such as the load 309, may be coupled to the battery 307.

The load 309 may comprise various circuitry in the wireless device that may be in operation during the charging of the battery 307, and may comprise processors, audio circuitry, power management circuitry and RF circuitry, for example.

The processor 305 may comprise suitable circuitry, logic and/or code that may control the operation of the wireless device and may be enabled to generate an output signal I_{TH} that corresponds to the load current on the battery 307. The processor 305 output signal I_{TH} corresponding to the load current may be communicated to the current comparator 303. In an embodiment of the invention, the processor 305 may be enabled to control the charging process, described with respect to FIG. 2, via the current source 301.

The memory 311 may comprise suitable circuitry, logic and/or code that may enable storage of data. The data stored in the memory 311 may be utilized by the processor 305 for various control functions in the wireless device and/or for charging control. In an exemplary embodiment of the invention the memory 311 may store data such as the charge complete threshold as described with respect to FIG. 2.

In operation, the current source 301 may be enabled by the processor 305 to provide the current I₁ to charge the battery 307, as described with respect to FIG. 2, and also to power the load 309. The processor 305 may determine the amount of load current I₁ through the load 309, and may generate an output signal I_{TH} that may be proportional to the load current I_{L} plus the known charge complete current of the battery 307. The current comparator 303 may compare the output signal I_{TH} at the ‘−’ input to the signal received at the ‘+’ input that may be proportional to the current I₁. In this manner, in instances where the current I₁ may be reduced to the load current plus the known charge complete current of the battery 307, the current comparator 303 may communicate an output signal I_{TH} to the processor 305 that may then stop supplying charging current to the battery 307 via the current source 301.

In another embodiment of the invention, the current source 301 may be replaced by a Thevenin equivalent voltage source in parallel with the battery 307.

The processor 305 may also adjust the charging time of the battery 307 by adjusting the current supplied by the current source 301 such that the charging process may complete at a particular time that may be stored in the memory 311. In another embodiment of the invention, the measurement of the load current may also be utilized to improve the constant current phase of the charging process. In an exemplary embodiment, where the optimal charge current for a specific battery may be 60 mA, for example, and the load current may be 10 mA, the constant current of the current source 301 may be set to 70 mA.

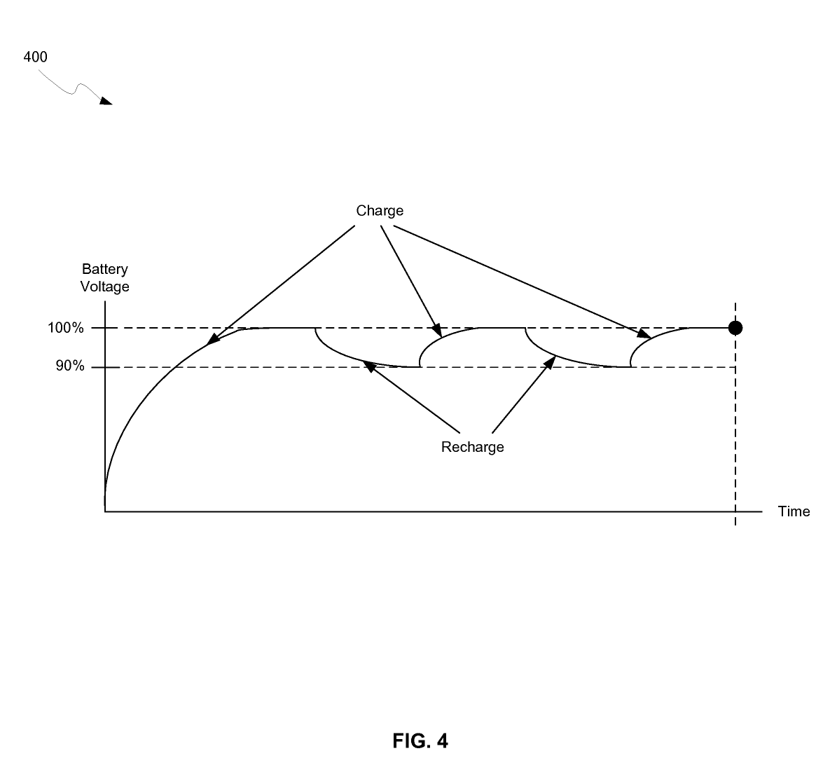

FIG. 4 is a block diagram illustrating an exemplary battery charge and recharge process, in accordance with an embodiment of the invention. Referring to FIG. 4, there is shown a voltage versus time curve 400 for a battery during charging and recharging. Recharging may comprise the time after the battery has reached maximum voltage and the charging voltage may be removed. During this time, the voltage across the battery may decrease, to 90% of full charge, for example. Following a recharge cycle, a charging voltage may be reapplied to charge the battery back up to full voltage. In this manner, a battery, such as a lithium battery, for example, may have extended lifetime.

In instances when a wireless device, such as the wireless headset 100, described with respect to FIG. 1, or a cell phone, may be coupled to a charger in the evening to be disconnected in the morning, for example, increased battery lifetime may be achieved by configuring the charging cycle to be at the 100% voltage level when the device may be decoupled from the charging source.

In an embodiment of the invention, the battery charging process may be configured to predict when the battery charging source may be decoupled from the device, and adjust charging current and/or voltage accordingly, such that the peak voltage may be obtained at a desired time. The wireless device may store the charging habits of its user to predict when a charging process may be optimally completed. Accordingly, the processor 305 may store the timing characteristics of the user, such as when the user typically leaves each morning disconnecting the charger, for example, and may store this data in memory, such as the memory 311, described with respect to FIG. 3. If a user typically starts a charging process in the evening and unplugs the charger from the wireless device before leaving for work at essentially the same time each day, for example, the processor 305 may configure the charging process to complete at that time. The stored characteristics of the user, or user preferences, may be updated regularly with each charging process.

The processor may also adjust the charging time by controlling the charging current supplied to the battery, as described with respect to FIG. 3. In this manner, customized charging characteristics may be generated for a wireless device user such that the battery lifetime may be maximized as per the usage patterns.

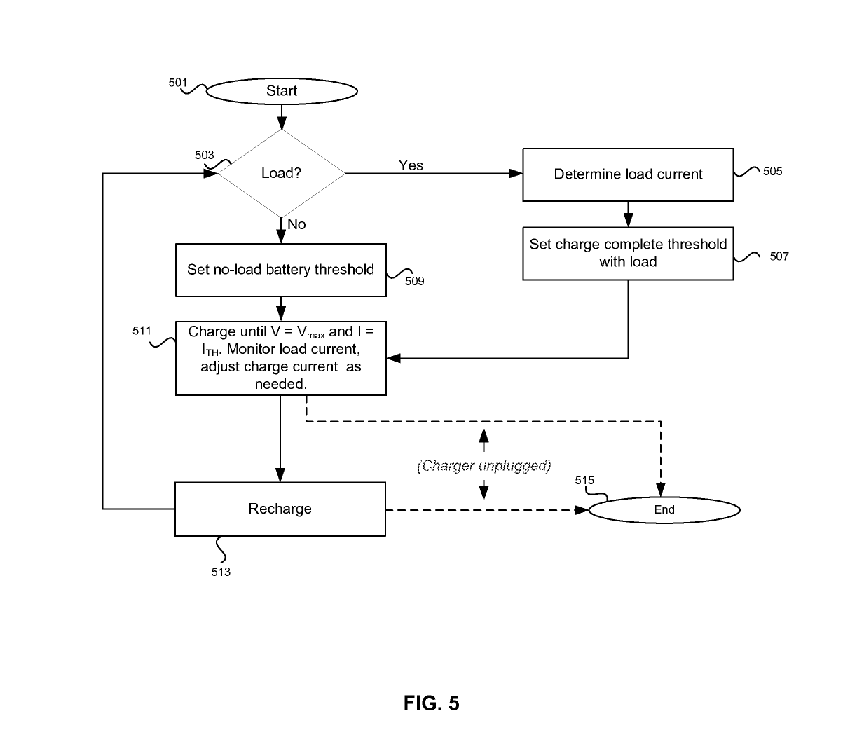

FIG. 5 is a flow diagram illustrating an exemplary charging operation of a wireless headset, in accordance with an embodiment of the invention. Referring to FIG. 5, in step 503, following start step 501, in instances where a load may be coupled to the battery, the process may proceed to step 505 where the load current may be determined, either by direct measurement or from stored values for the current state of the headset 100. In step 507, the determined load current may be utilized to set a threshold current that may be obtained to indicate when charging may be complete, followed by step 511 where the battery may be charged.

If in step 503, in instances where no load may be present, the exemplary steps may proceed to step 509 where the battery charge complete threshold may be set, followed by step 511 where the battery may be charged until the battery voltage reaches maximum and the charge current may reach the charge complete threshold. Additionally, the load current may be monitored, and the battery charge current may be adjusted based on changes in the measured load current. In instances where the battery charger may be unplugged, the exemplary steps may proceed to end step 515.

The exemplary steps may then proceed to step 513 where the battery may be allowed to recharge, and the voltage across the battery may decrease. In instances where the battery charger may be unplugged, the exemplary steps may proceed to end step 515. If the battery charger may not be unplugged, the process may proceed to step 503 to repeat the charge process. The load current may again be monitored, and the charging current may be adjusted based on changes in the load current.

In an embodiment of the invention, a method and system are provided for power and charging control in a Bluetooth headset and may comprise measuring a load current during charging of one or more batteries 307 in a mobile device, such as the wireless headset 100. A completion time may be predicted for the charging and may be terminated based on a sum of the measured load current, I_{L}, and a known charge complete threshold current of the batteries 307, which may comprise lithium batteries. A current source 301 or voltage source may be controlled for the charging of the batteries 307. A current, I₁, from the current source 301 may be compared to the sum of the measured load current, I_{L}, and the known charge complete threshold current via a current comparator 303. A rate of charging may be controlled for charging the batteries 307 to a desired end voltage based on the predicted completion time. A user preference based on the predicted completion time may be stored, wherein the user preference may be utilized to control one or more subsequent charges of the batteries 307.

Certain embodiments of the invention may comprise a machine-readable storage having stored thereon, a computer program having at least one code section for power and charging control in a Bluetooth headset, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for power control, the method comprising:
in a mobile device,
measuring a load current during charging of one or more batteries in said mobile device;
predicting a completion time of said charging; and
terminating said charging of said one or more batteries based on a sum of said measured load current and a known charge complete threshold current of said one or more batteries.

2. The method according to claim 1, comprising controlling a current source for said charging of said one or more batteries.

3. The method according to claim 2, comprising comparing a current from said current source to said sum of said load current and said known charge complete threshold current via a current comparator.

4. The method according to claim 1, comprising controlling a voltage source for said charging of said one or more batteries.

5. The method according to claim 1, wherein said one or more batteries comprise lithium batteries.

6. The method according to claim 1, wherein said mobile device comprises a Bluetooth headset.

7. The method according to claim 1, comprising controlling a rate of said charging of said one or more batteries to a desired end voltage based on said predicted completion time.

8. The method according to claim 1, comprising storing a user preference based on said predicted completion time, wherein said user preference is utilized to control one or more subsequent charges of said one or more batteries.

9. A system for power control, the system comprising:
one or more circuits within a mobile headset that measure a load current during charging of one or more batteries in said mobile device;
said one or more circuits predict a completion time of said charging; and
said one or more circuits terminate said charging of said one or more batteries based on a sum of said measured load current and a known charge complete threshold current of said one or more batteries.

10. The system according to claim 9, wherein said one or more circuits control a current source for said charging of said one or more batteries.

11. The system according to claim 10, wherein said one or more circuits comprises a current comparator that is enabled to compare a current from said current source to said sum of said load current and said known charge complete threshold current.

12. The system according to claim 9, wherein said one or more circuits control a voltage source for said charging of said one or more batteries.

13. The system according to claim 9, wherein said one or more batteries comprise lithium batteries.

14. The system according to claim 9, wherein said mobile device comprises a Bluetooth headset.

15. The system according to claim 9, wherein said one or more circuits control a rate of charging of said one or more batteries to a desired end voltage based on said predicted completion time.

16. The system according to claim 9, wherein said one or more circuits store a user preference based on said predicted completion time, wherein said user preference is utilized to control one or more subsequent charges of said one or more batteries.

17. A machine-readable storage having stored thereon, a computer program having at least one code section for power control, the at least one code section being executable by a machine for causing the machine to perform steps comprising:
measuring a load current during charging of one or more batteries in a mobile device;
predicting a completion time of said charging; and
terminating said charging of said one or more batteries based on a sum of said measured load current and a known charge complete threshold current of said one or more batteries.

18. The machine readable storage according to claim 17, wherein said at least one code section comprises code for controlling a current source for said charging of said one or more batteries.

19. The machine readable storage according to claim 18, wherein said at least one code section comprises code for comparing a current from said current source to said sum of said load current and said known charge complete threshold current via a current comparator.

20. The machine readable storage according to claim 17, wherein said at least one code section comprises code for controlling a voltage source for said charging of said one or more batteries.

21. The machine readable storage according to claim 17, wherein said one or more batteries comprise lithium batteries.

22. The machine readable storage according to claim 17, wherein said mobile device comprises a Bluetooth headset.

23. The machine readable storage according to claim 17, wherein said at least one code section comprises code for controlling a rate of charging of said one or more batteries to a desired end voltage based on said predicted completion time.

24. The machine readable storage according to claim 17, wherein said at least one code section comprises code for storing a user preference based on said predicted completion time, wherein said user preference is utilized to control one or more subsequent charges of said one or more batteries.
